(19) United States
(12) Patent Application Publication
(10) Pub. No.: US 2009/0008254 A1
(43) Pub. Date: Jan. 8, 2009

(54) Microfluidic System and Corresponding Control Method

(75) Inventors: Torsten Müller, Berlin (DE); Thomas Schnelle, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: EVOTEC TECHNOLOGIES GmbH, Düsseldorf (DE)

(21) Appl. No.: 11/908,605

(22) PCT Filed: Mar. 16, 2006
(86) PCT No.: PCT/EP2006/002431

§ 371 Date: Apr. 30, 2008

(30) Foreign Application Priority Data
Mar. 16, 2005 (DE) 10 2005 012 128.4

(51) Int. Cl. B01D 57/02; C25B 11/00

(52) U.S. Cl. 204/547; 204/643

(57) ABSTRACT

The invention relates to a microfluidic system containing a carrier current channel (1) for receiving a carrier current containing particles suspended therein, and at least one electrode arrangement (3) which is arranged in the carrier current channel and used to manipulate the suspended particles (2), the electrode arrangement (3) containing two manipulation electrodes (4, 5). According to the invention, the electrode arrangement (3) contains two centering electrodes (6, 7), in addition to the two manipulation electrodes (4, 5), for centering the particles, the two centering electrodes (6, 7) being arranged in the carrier current channel (1) respectively upstream of one of the two manipulation electrodes (4, 5). The invention also relates to a corresponding control method.

The invention relates to a microfluidic system and an associated control method in accordance with the preamble of the secondary claims.

Such microfluidic systems are known, e.g., from Müller, T. et al.: “A 3D-micro electrode for handling and caging single cells and particles”, Biosensors and Bioelectronics 14, 247-256, 1999 and have a flat carrier flow channel for receiving a carrier flow with particles suspended in it (e.g., biological cells), in which carrier flow channel a dielectrophoretic electrode arrangement is located in order to manipulate the suspended particles. For example, the suspended particles can be centered in the carrier flow by a funnel-shaped electrode arrangement (“funnel”) or fixed by a so-called hook.

However, a disadvantage of the known microfluidic holding systems, e.g., the above-cited dielectrophoretic hooks, is the fact that the particles can be pressed up or down towards the channel wall by the dielectrophoretic electrode arrangement in the carrier flow channel, which is problematic especially in the case of biological cells.

The use of dielectrophoretic field cages for fixing suspended particles in a field minimum inside the field cage is known from Schnelle, T. et al.: “Trapping of Viruses in High Frequency Electric Field Cages”, Naturwissenschaften 83, 172-176 (1996), Springer-Verlag. These field cages have eight cubically arranged cage electrodes and center the suspended particles in all spatial directions, which is necessary here in order to prevent an adhesion of the particles to the channel walls. To this end, an individual electrical supply of the cage electrodes is necessary, which is technically very expensive and makes it difficult, e.g., to achieve the ability to parallelize.

Other exemplary embodiments of such field cages are known from Fuhr, G. et al.: “Positioning and Manipulation of Cells and Microparticles Using Miniaturized Electric Field Traps and Travelling Waves”, Sensors and Materials, Vol. 7, No. 2 (1995) 131-146.

The subsequently published patent application DE 10 2004 017 482 A1 also discloses microfluidic systems with dielectrophoretic elements such as, e.g., the already initially cited field cages, funnels as well as particle switches. However, the field cages center the suspended particles in all spatial directions, which is necessary here in order to prevent an adhesion of the suspended particles on the channel walls of the carrier flow channel.

So-called biochips are known from US2002/0182627 A1 in which suspended particles are manipulated by electrophoresis. Moreover, this patent application also discloses planar dielectrophoretic field cages that position a suspended particle in a bore of a plate. However, this type of fixation results in a purposeful manner in a touching contact between the fixed particle and the channel delimitation, which is especially problematic in the case of biological cells.

Furthermore, DE 199 52 322 C2, DE 103 11 716 A1 and U.S. Pat. No. 5,454,472 disclose methods and devices for separating suspended particles by means of dielectrophoretic elements. However, no measures are known from these patent applications for preventing the adhesion of suspended particles to the channel walls.

It is therefore an object of the invention to appropriately improve and simplify the initially described known microfluidic holding systems, during which it should be prevented that the suspended particles are pressed by the electrode arrangement in the direction of the channel wall.

This object is achieved by a microfluidic system in accordance with the invention and by an associated control method in accordance with the secondary claims.

The invention comprises the general technical teaching of arranging centering electrodes upstream before the manipulation electrode (e.g., a so-called “hook”), which centering electrodes focus the particles suspended in the carrier flow in the central plane of the carrier flow channel, thus preventing the suspended particles from being pressed in the direction of the channel wall.

The concept of centering or focusing used in the framework of the invention preferably means that the suspended particles are centered or focused at a right angle to the direction of flow.

The microfluidic system in accordance with the invention includes an electrode arrangement with at least two manipulation electrodes and at least two centering electrodes arranged upstream before the manipulation electrodes.

The two manipulation electrodes can be, e.g., so-called hooks that are already known from the initially cited publication by Müller, T. et al.: “A 3D-micro electrode for handling and caging single cells and particles”, Biosensors and Bioelectronics 14, 247-256, 1999, so that the content of this publication is to be added to its full extent to the present description as regards the design of the manipulation electrodes.

Furthermore, it should be mentioned that the manipulation electrodes do not necessarily have to be in one piece or continuous, but rather there is also the possibility that individual manipulation electrodes consist of several partial electrodes and that the individual partial electrodes of the manipulation electrodes can be separately controlled. For example, the individual manipulation electrodes can also be interrupted by passivation layers.

However, it is important that the manipulation electrodes are curved in opposition to the direction of flow such as is the case, e.g., with the known so-called hooks. However, there is also the possibility, instead of hook-shaped manipulation electrodes, that the manipulation electrodes are arcuate (e.g., semicircular) or closed in a ring form. However, they can also have the form of a rectangle or of a part of a rectangle, of a hexagon or in general of a polygon. Therefore, the form can be almost as desired, just as in the case of the centering electrodes. For example, the manipulation electrodes can be in the form of a circular ring, which makes it possible to arrange several particles on closed paths.

The invention furthermore provides that the centering electrodes are at least partially surrounded by the manipulation electrodes arranged downstream behind them. In the case of a hook-shaped manipulation electrode this can be readily achieved in that the associated centering electrode is preferably arranged between the two shanks of the hook-shaped manipulation electrode. In the case of a ring-shaped manipulation electrode the associated centering electrode can be arranged inside the manipulation electrode.

In addition, the invention provides that the centering electrodes have a lesser spatial extension transversely to the direction of flow than the manipulation electrodes, which is not the case with the initially mentioned field cages with eight cubically arranged cage electrodes.

The centering electrodes are preferably triangular, rectangular, hexagonal, round, circular or elliptical in form, with the centering electrodes being preferably smaller than the manipulation electrodes transversely to the direction of flow.

It should furthermore be mentioned that the two centering electrodes can be controlled separated electrically from one another in a preferred embodiment in order that the centering electrodes can be controlled in electrical phase opposition.

The same also preferably applies to the two manipulation electrodes that can preferably also be controlled electrically separated from one another in order to make possible a control in phase opposition.

Moreover, even the manipulation electrodes on the one hand and the centering electrodes on the other hand can be controlled in an electrically separated manner since the manipulation electrodes and the centering electrodes associated with them should be controlled in an electrical phase opposition in order to achieve a centering action.

It should furthermore be mentioned that the two manipulation electrodes and/or the two centering electrodes are preferably substantially planar (that is, level), wherein the two manipulation electrodes on the one hand and the two centering electrodes are preferably each arranged in pairs in a substantially coplanar manner. That means that the individual electrodes are arranged in two planes parallel to one another, wherein in each case one manipulation electrode and one associated centering electrode are present in each plane. In comparison to the field cage the suggested arrangement is more robust against shifting, which facilitates the manufacture of the systems.

The centering electrodes and the manipulation electrodes are arranged here in the direction of flow at a distance from each other that is preferably in a range of ⅛ to twice the distance of the electrode planes. For handling animal suspension cells, e.g., blood cells, this is preferably in a range of 5 μm to 80 μm and a distance of approximately 40 μm has proven to be especially advantageous.

In an advantageous variant of the invention the electrode arrangement has several manipulation electrode pairs and centering electrode pairs associated with the latter. The individual manipulation electrode pairs can be arranged relative to the direction of flow adjacent to each other or behind one another in the carrier flow channel. This array arrangement permits, in comparison to traditional dielectrophoretic cages, a simpler and better long-time cultivation of biological cells in microfluidic chips. For example, several so-called hooks can be arranged adjacent to each other in the direction of flow in order to fix suspended particles.

The individual manipulation electrode pairs can be electrically connected to each other, which makes possible a common electrical control in which the individual manipulation electrodes of a manipulation electrode pair are controlled in a traditional manner in phase opposition.

However, there is also the alternative possibility that the individual manipulation electrode pairs are electrically separated from each other at least partially and are separately controlled in an at least partially electrical manner, which makes possible a simple selective detection of the suspended particles.

Furthermore, the scope of the invention includes the goal of minimizing the thermal load of the suspended particles, which is especially important in the case of biological cells. However, the thermal stress of the suspended particles is a function of the electrode width and of the electrode distance, which parameters also influence the force which the electrode arrangement exerts on the suspended particles. The lateral electrode width is preferably in the range of 10% to 50% of the electrode distance between the planes since the ratio of the desired force to the undesired warming of the suspended particles is especially good in this range.

Furthermore, it should be mentioned that the carrier flow channel of the microfluidic system of the invention preferably has a cross section of flow in the range of 0.006 mm² to 0.6 mm², which is customary in microfluidic systems. The height of the carrier flow channel here can be, e.g., in the range of 1 μm to 400 μm whereas the width of the carrier flow channel can be, e.g., in the range of 5 μm to 1.5 mm.

In general, the cross section of the carrier flow channel can be different, thus it can be, e.g., rectangular or trapezoidal.

Furthermore, there is the possibility that the two manipulation electrodes of the electrode arrangement of the invention, which are arranged in a coplanar manner, are arranged offset to one another in the direction of flow. In the same manner even the two centering electrodes of the electrode arrangement are offset to one another in the direction of flow. The offset in the direction of flow in relation to the distance between the manipulation electrodes and the centering electrodes can be in a range of 5% to 95%, 10% to 90%, 20% to 80% or 30% to 70%. The possibility of offsetting the electrodes has the advantage that as a result not so high requirements have to be placed on the manufacturing process as, e.g., in the case of the already known field cages, in which an exact alignment of the decoupling layers is basic for the functionality.

However, the invention comprises not only the microfluidic system in accordance with the invention but also a biological apparatus (e.g., a cell sorter) with such a microfluidic system.

Furthermore, the invention comprises an associated control method for such a microfluidic system. In it the manipulation electrodes on the one hand and the centering electrodes associated with them on the other hand are preferably electrically controlled in phase opposition in order to achieve the desired centering effect.

Alternatively, the arrangement can also be operated in a single-phase manner. The control takes place as was described above, wherein the second phase is replaced by earth or free potential. This represents a significant simplification in comparison to the known field cage (2- or 4-phase control). Not only the chip and the control electronics are simplified but even the requirements on the interface (capacitances, inductivities) are reduced since phase shifts and runtime delays become less important.

Furthermore there is the possibility that the centering electrodes are cut out when a particle has been fixed by the associated manipulation electrodes. The trapped particles then remain nevertheless in spite of the cutting out of the centering electrodes in the hydrodynamic flow in the central plane before the manipulation electrodes located downstream. As a result thereof, the thermal as well as the electrical load of the trapped particles is reduced, which is especially significant for biological cells.

The cutting out of the centering electrodes can take place selectively in that the centering electrodes are switched to earth or in a potential-free manner, the centering electrodes having a floating electrical potential in the case of a potential-free switching.

There is furthermore the possibility that the centering electrodes are briefly controlled with an elevated electrical voltage before they are cut out.

Moreover, the flow rate in the carrier flow channel can be briefly elevated shortly before the centering electrodes are cut out.

In an advantageous variant of the invention the centering electrodes serve not only to center the suspended particles in the carrier flow channel but also to examine the suspended particles. For example, the centering electrode can first bring about the centering of the suspended particles trapped by the manipulation electrodes arranged downstream. During this centering phase the manipulation electrodes and the centering electrodes are electrically controlled in phase opposition, as explained above. After the suspended particles have been trapped by the manipulation electrodes the centering electrodes can then be used as measuring electrodes. To this end, the centering electrodes are separated from the electrical control and connected to an appropriate measuring apparatus. For example, the centering electrodes can be used as impedance-measuring electrodes and carry out an impedance-spectroscopic examination of the trapped particles. This has the advantage of a good signal-to-noise ratio since the centering electrodes and/or measuring electrodes have a small size and the particles to be examined are fixed close to the centering electrodes and/or measuring electrodes.

In a variant of the invention the electrode arrangement has ring-shaped manipulation electrodes on the upper channel wall of the carrier flow channel as well as on the lower channel wall of the carrier flow channel. The manipulation electrodes on the upper channel wall on the one hand and on the lower channel wall on the other hand are preferably electrically controlled in phase opposition. There is, however, also the alternative possibility that the manipulation electrodes on the lower channel wall are on earth and only the manipulation electrodes on the upper channel wall are electrically controlled. Furthermore, there is also the possibility that the manipulation electrodes on the upper channel wall are on earth and only the manipulation electrodes on the lower channel wall are electrically controlled. Furthermore, there is the possibility that the manipulation electrodes on the upper channel wall on the one hand and on the lower channel wall on the other hand are electrically controlled with a phase difference of 900 in order, e.g., to generate rotation fields.

In the previously described exemplary embodiments with ring-shaped manipulation electrodes the centering electrodes are preferably located in the middle of the ring-shaped manipulation electrodes. The centering electrodes can be electrically on earth here. Alternatively, there is the possibility that only the centering electrodes on the upper channel wall or only the centering electrodes on the lower channel wall are on earth whereas the particular other centering electrodes are electrically controlled. In a variant of the invention the electrical control of the centering electrodes on the upper channel wall on the one hand and on the lower channel wall on the other hand takes place electrically in phase opposition.

Furthermore, there is the possibility that the ring-shaped manipulation electrodes are interrupted and consist of several electrode segments with the form of a segment of a circle that are, however, electrically connected to each other. The interruptions between the individual electrode segments advantageously make it possible for particles to enter into the electrode arrangement and for particles to exit from the electrode arrangement.

Furthermore, there is the possibility here that the individual electrode segments have outwardly projecting shanks, wherein the outwardly projecting shanks of adjacent electrode segments form a funnel-shaped electrode arrangement like the one initially explained in the description of the state of the art. These funnel-shaped electrode arrangements facilitate the introduction of particles into the electrode arrangement.

Furthermore, there is the possibility that particle switches like the ones known from the initially mentioned publication of Müller, T. et al.: “A 3D-micro electrode for handling and caging single cells and particles”, Biosensors and Bioelectronics 247-256, 1999 are arranged downstream behind the electrode arrangements. The particles exiting from the field cages can then be selectively transported into a further electrode arrangement by the particle switches located behind them or deflected laterally.

In an advantageous exemplary embodiment of the invention a plurality of electrode arrangements is provided arranged in a matrix shape that each have at least one centering electrode and at least one manipulation electrode. The individual electrode arrangements can be constructed in accordance with the previously described variants. Preferably two row control lines are provided here for each row of the electrode arrangements, the one row control line of which being connected to the centering electrodes of the electrode arrangements of the particular row whereas the other row control line is connected to the manipulation electrodes of the electrode arrangements of the particular row. In addition, two column control lines are provided for each column and the one column control line is connected to the centering electrodes of all electrode arrangements of the particular column whereas the other column control line is connected to the manipulation electrodes of all electrode arrangements of the particular column. Each centering electrode and manipulation electrode is therefore connected to a row control line and to a column control line. In this manner certain electrode arrangements can be cut out in a purposeful manner in that the two associated row and column control lines are switched to earth or free potential. However, the other electrode arrangements then remain cut in.

Other advantageous further developments of the invention are characterized in the subclaims or are explained in detail in the following together with the description of the preferred exemplary embodiments of the invention with reference made to the figures, in which:

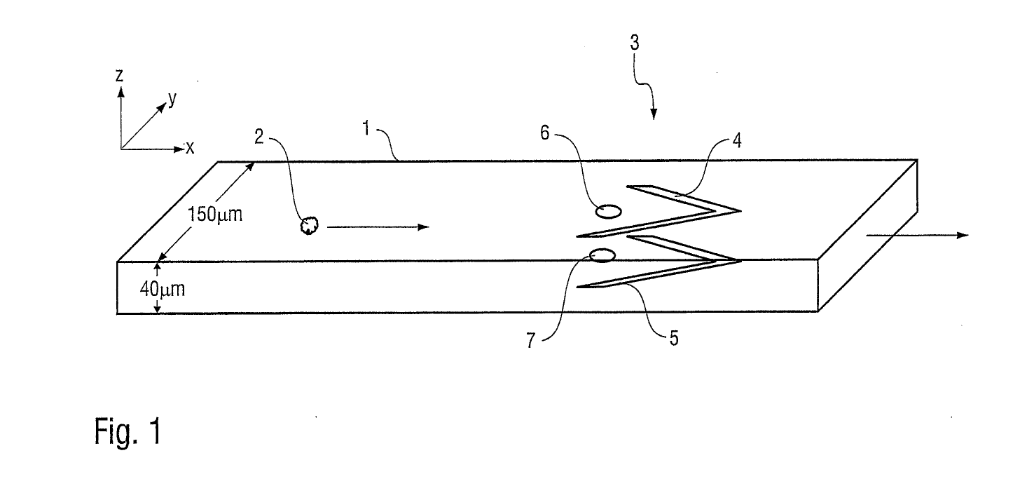

FIG. 1 shows a simplified perspective representation of a microfluidic system in accordance with the invention,

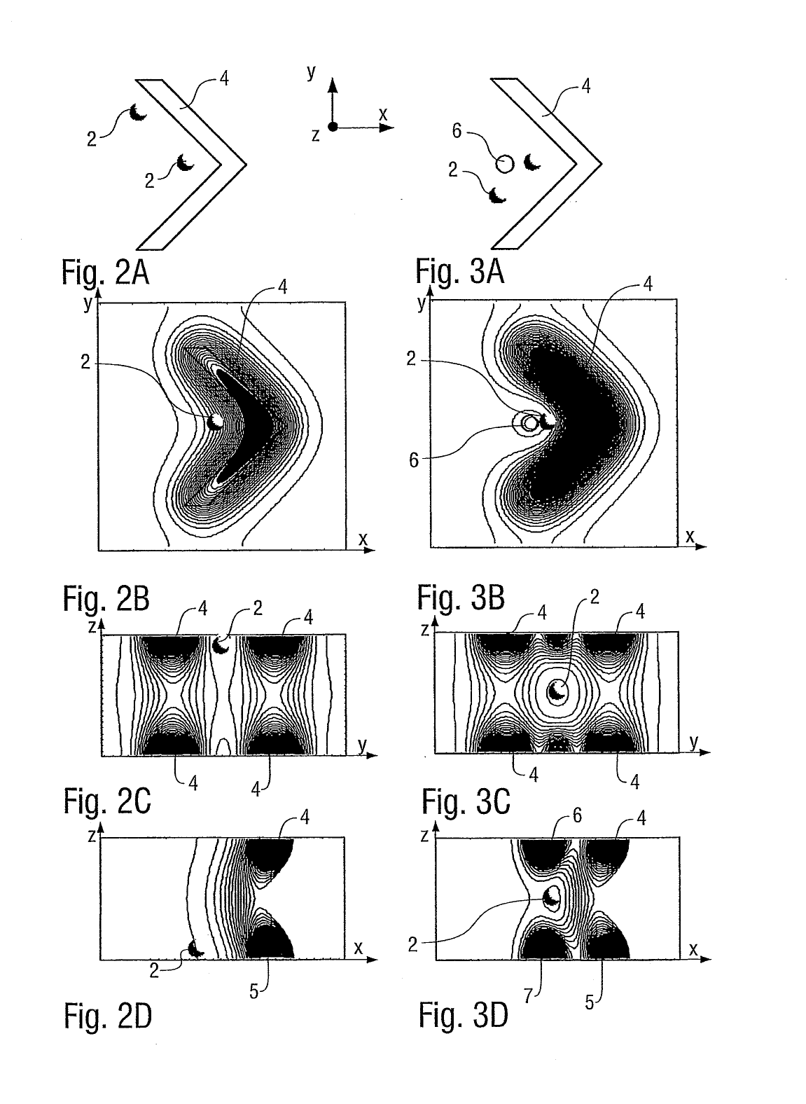

FIGS. 2A-2D show different views of a traditional microfluidic system,

FIGS. 3A-3D show views corresponding to FIGS. 2A-2D in a microfluidic system in accordance with the invention,

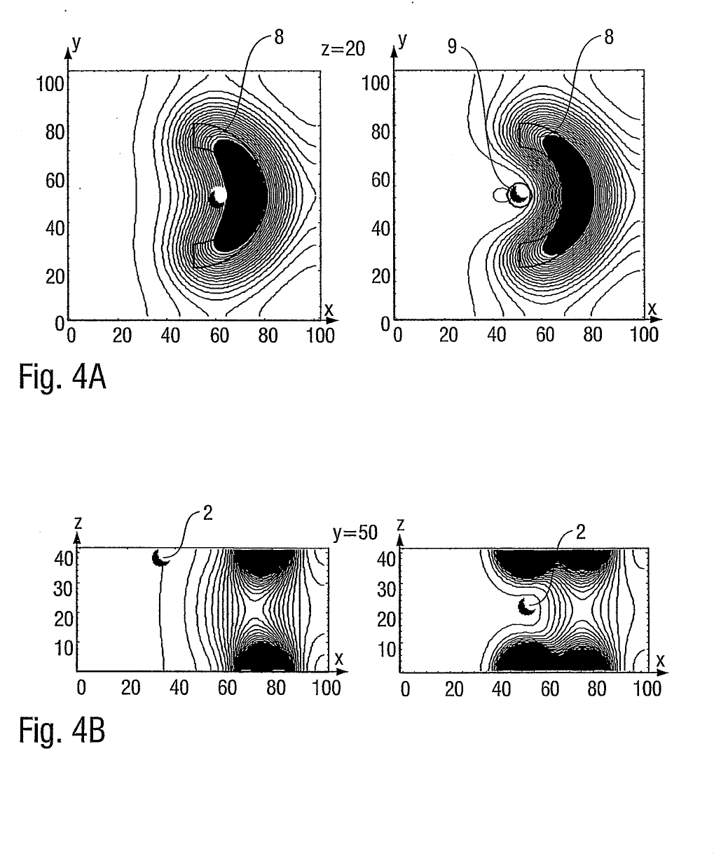

FIGS. 4A, 4B show different views of an electrode arrangement of another exemplary embodiment of a microfluidic system in accordance with the invention,

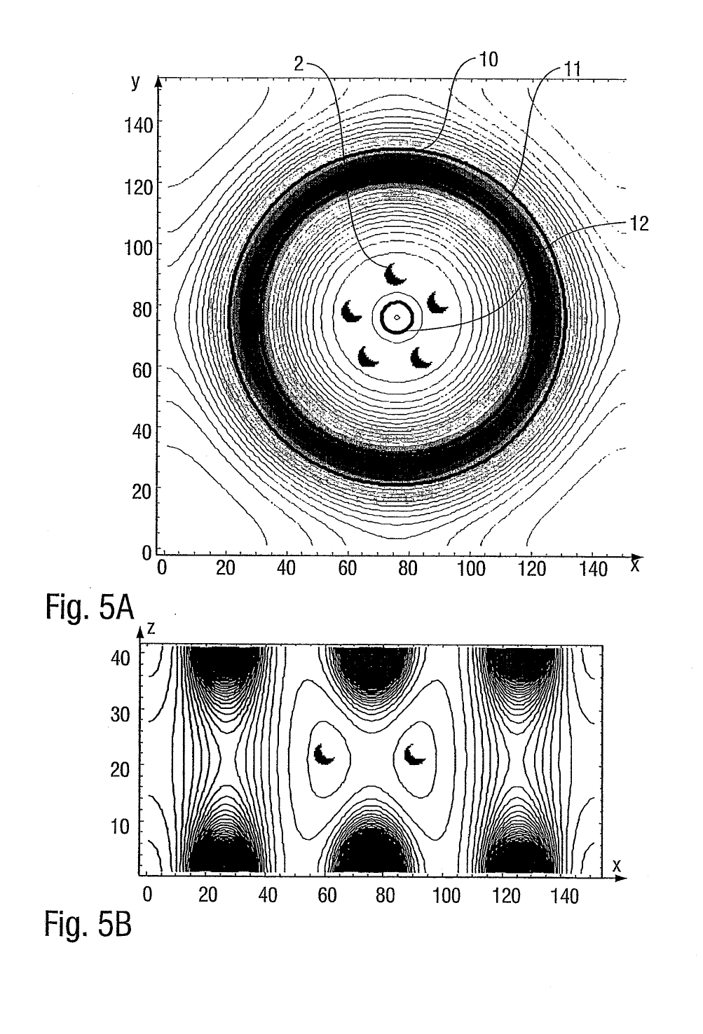

FIGS. 5A, 5B show another exemplary embodiment of an electrode arrangement in accordance with the invention,

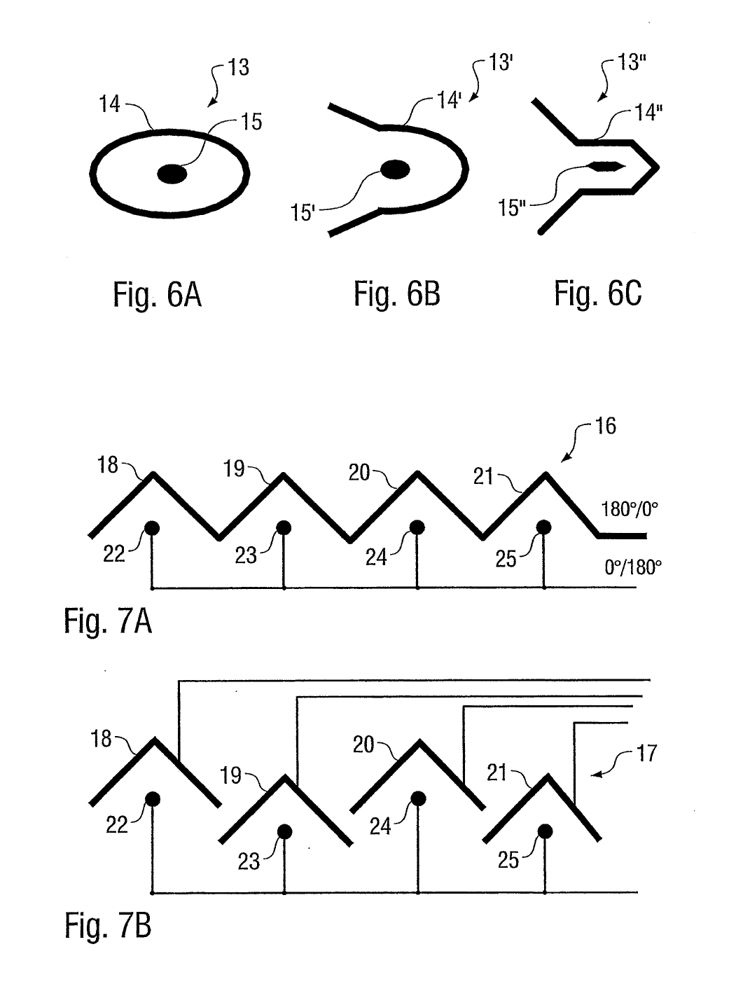

FIGS. 6A-6B show further variants of possible electrode arrangements in a microfluidic system in accordance with the invention,

FIGS. 7A, 7B show further exemplary embodiments of electrode arrangements that can be used in a microfluidic system in accordance with the invention,

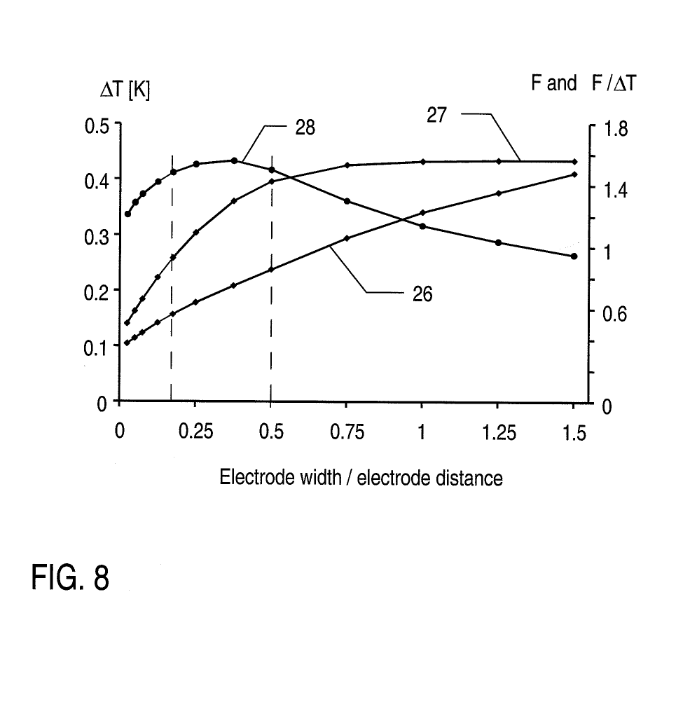

FIG. 8 shows a diagram that shows the warming produced by the electrode arrangement and the force exerted on the suspended particles as a function of electrode width and electrode distance,

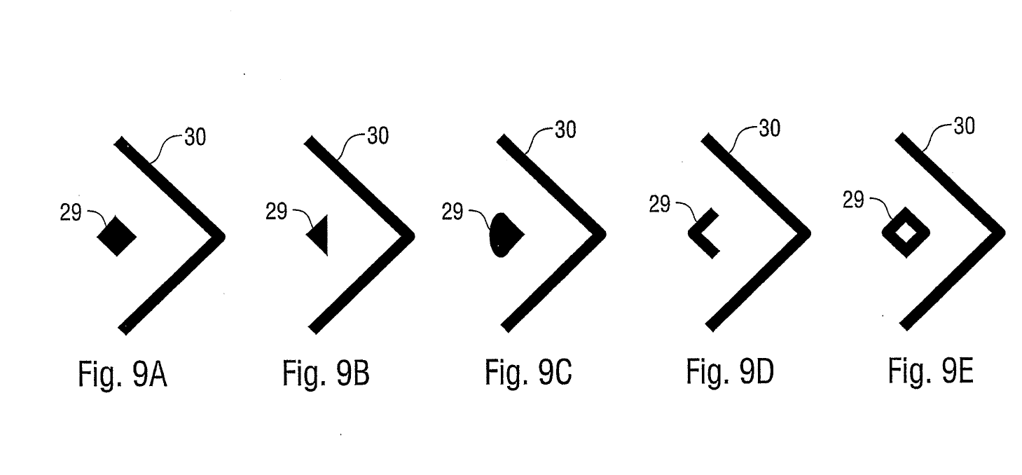

FIGS. 9A-9E show further variants of electrode arrangements in a microfluidic system in accordance with the invention,

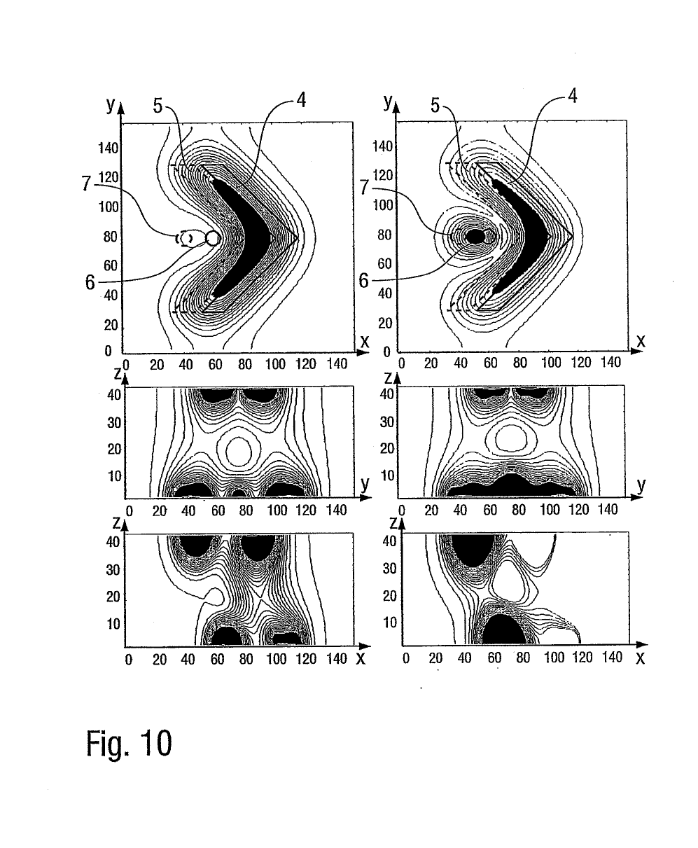

FIG. 10 shows various views of an electrode arrangement of a microfluidic system in accordance with the invention,

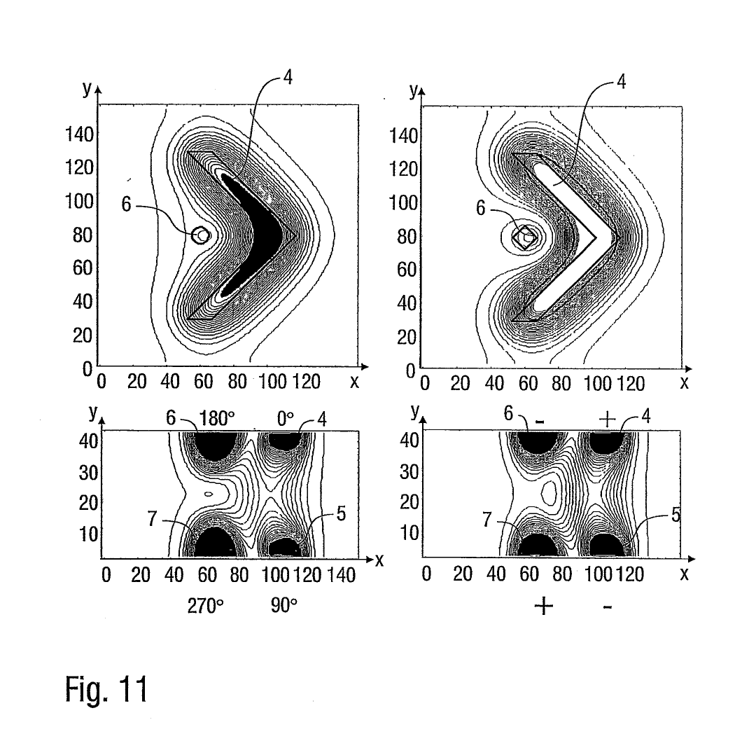

FIG. 11 shows various views of further electrode arrangements,

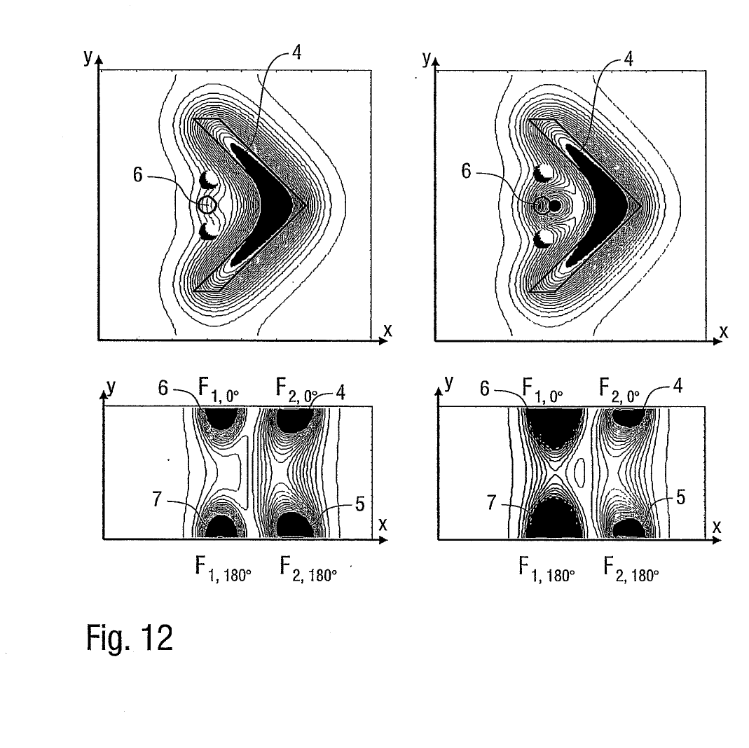

FIG. 12 shows various views of further electrode arrangements in which the centering electrodes on the one hand and the manipulation electrodes on the other hand are controlled with different frequencies,

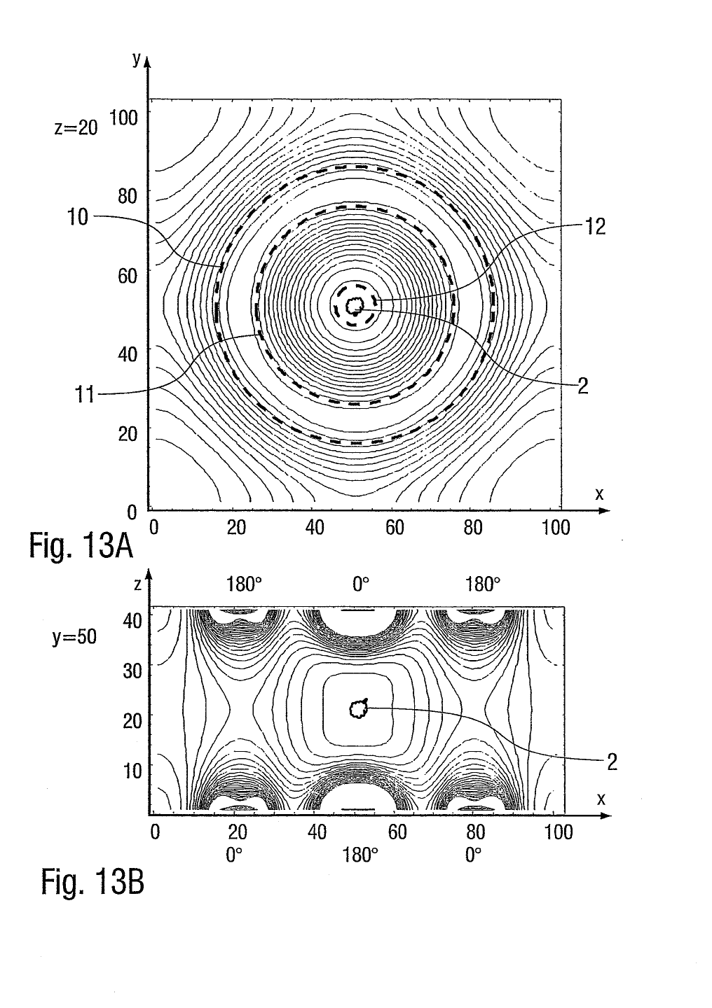

FIG. 13A, 13B show a variant of the exemplary embodiment according to FIGS. 5A and 5B,

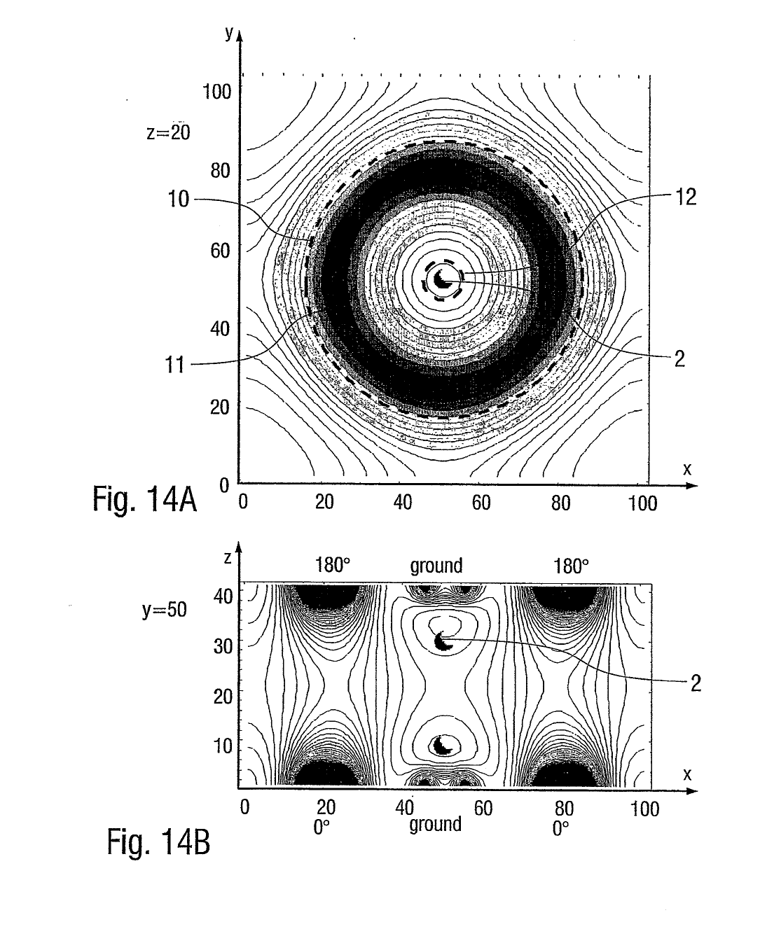

FIG. 14A, 14B show a further variant of an exemplary embodiment in accordance with the invention with circular centering electrodes and circular manipulation electrodes,

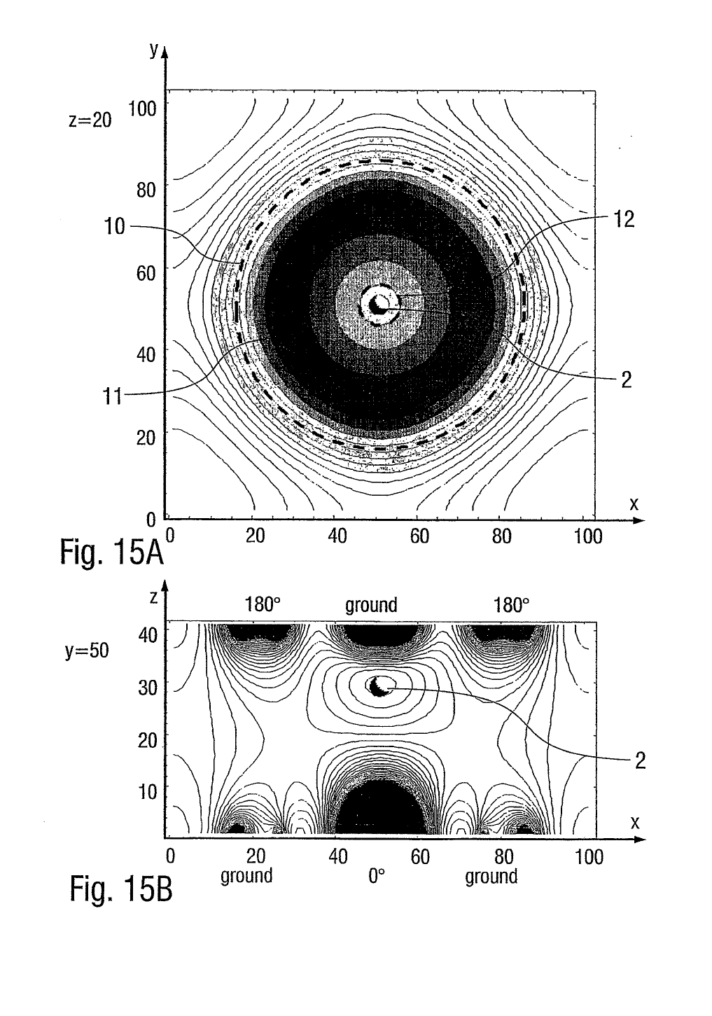

FIG. 15A, 15B show yet a further exemplary embodiment of an arrangement in accordance with the invention with circular centering electrode and circular manipulation electrodes, the control of the centering electrodes taking place in another manner,

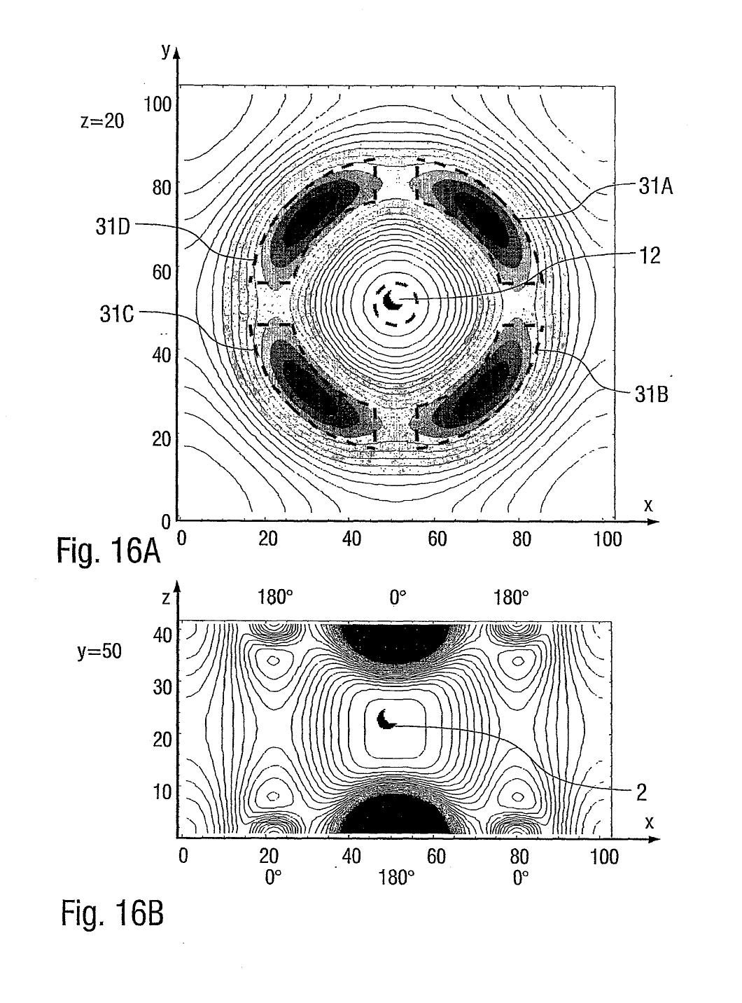

FIG. 16A, 16B show an alternative exemplary embodiment with manipulation electrodes in the form of a segment of a circle and with circular centering electrodes,

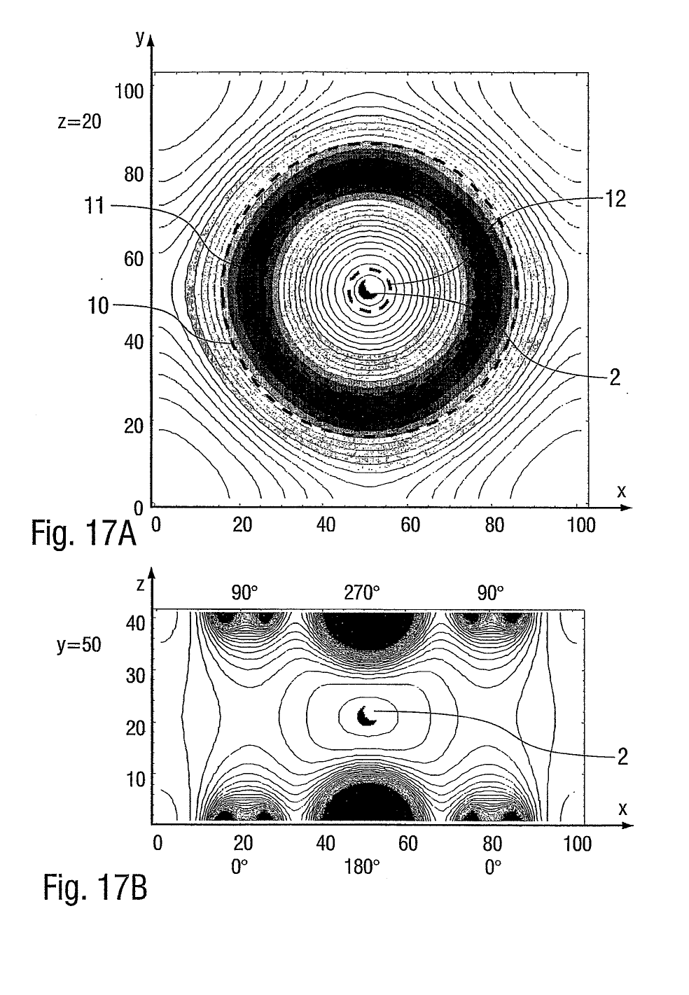

FIG. 17A, a7B show a further exemplary embodiment with circular ring-shaped manipulation electrodes and circular centering electrodes,

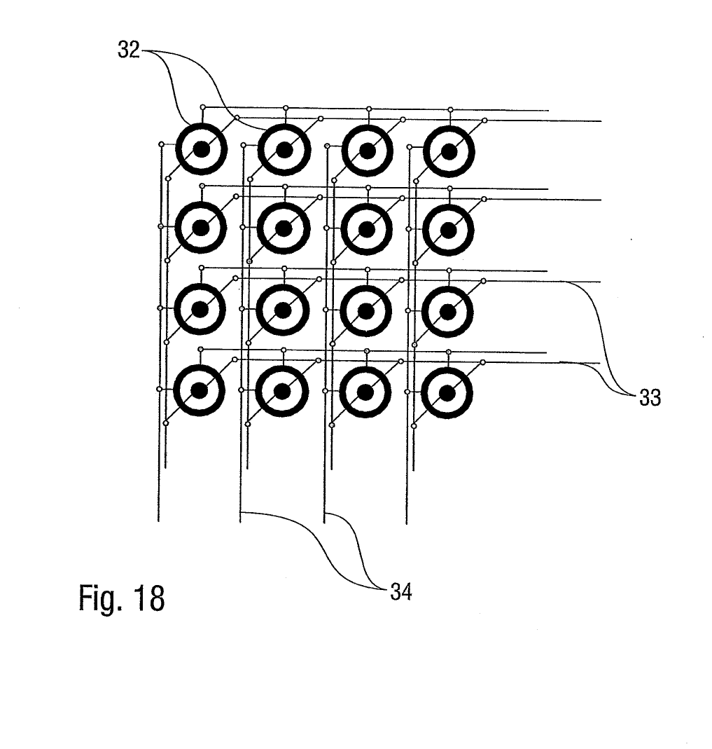

FIG. 18 shows a simplified representation of a matrix-shaped electrode arrangement in accordance with the invention with a plurality of circular-shaped and circular ring-shaped electrode structures,

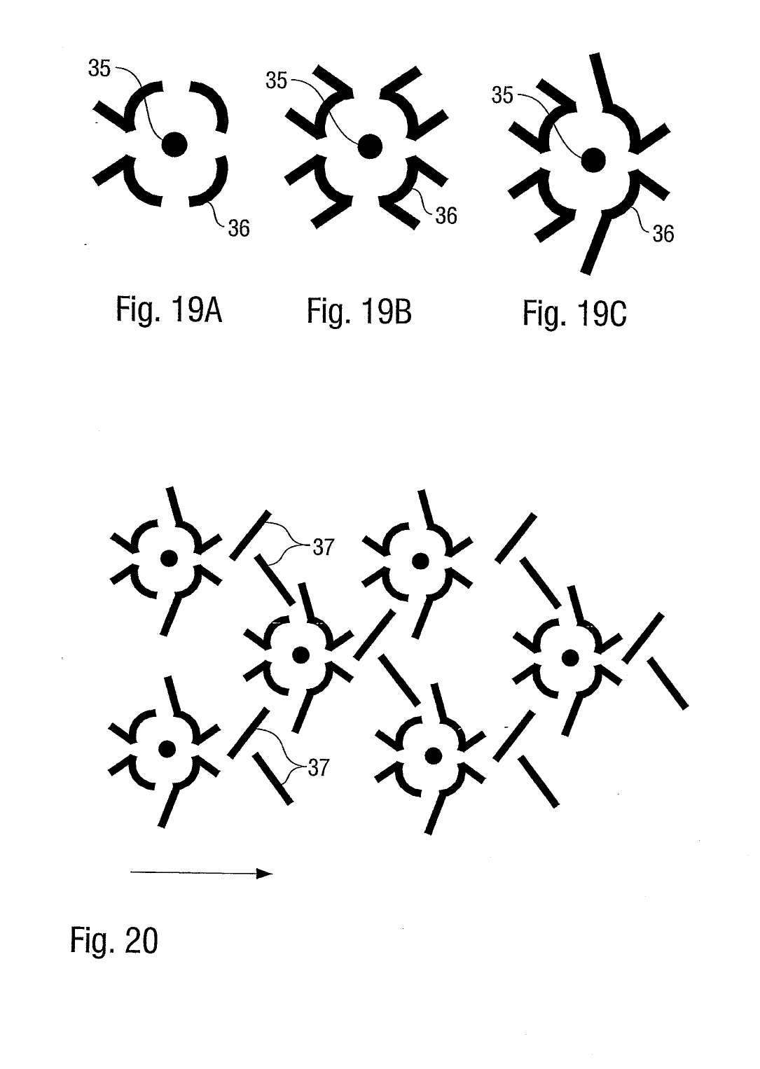

FIG. 19A-19C show further variants of electrode structures in accordance with the invention,

FIG. 20 shows an electrode structure in accordance with the invention with several electrode arrangements each having centering electrodes and manipulation electrodes.

The perspective view in FIG. 1 shows a carrier flow channel 1 of a microfluidic system such as can be used, e.g., in a cell sorter for sorting biological cells. The cell sorter itself can be designed here in a traditional manner so that a detailed description of the cell sorter can be dispensed with in the following.

The carrier flow channel 1 has a rectangular cross section here with a height of 40 μm and a width of 150 μm and conducts a carrier flow with particles suspended in it, where only one biological cell is schematically represented for the sake of simplification.

The carrier flow with the biological cells 2 suspended in it flows in the carrier flow channel 1 in direction x, as is illustrated by the arrows.

An electrode arrangement 3 is arranged in the carrier flow channel 1 and consists of two hook-shaped manipulation electrodes 4, 5 and two circular centering electrodes 6, 7.

The two manipulation electrodes 4, 5 are designed in a traditional manner and are correspondingly controlled, which is known from the publication of Müller, T. et al.: “A 3D-micro electrode for handling and caging single cells and particles”, Biosensors and Bioelectronics 14, 247-256, 1999 that was already mentioned initially, so that in order to avoid repetitions this publication is referred to, whose content is to be added to its full extent to the present description. It needs only be briefly mentioned at this point that the two manipulation electrodes 4, 5 are each designed in a planar manner and are aligned in a coplanar manner with one another, the manipulation electrode 4 being arranged on the upper channel wall of the carrier flow channel 1 whereas the other manipulation electrode 5 is arranged on the lower channel wall of the carrier flow channel 1.

The two centering electrodes 6, 7 are also designed in a planar manner and aligned in a coplanar manner with one another, the centering electrode 6 being arranged on the upper channel wall of the carrier flow channel 1 whereas the centering electrode 7 is arranged on the lower channel wall of the carrier flow channel 1. Therefore, the centering electrode 6 is located in a plane with the manipulation electrode 4 whereas the centering electrodes 7 is located in a plane with the manipulation electrode 5.

A distance of approximately 40-50 μm is present here in the direction of flow between the centering electrode 6 or 7, respectively and the associated manipulation electrode 4 or 5, respectively, which makes a good centering effect of the centering electrode 6, 7 possible.

During operation the manipulation electrodes 4, 5 are electrically controlled in phase opposition to one another just as the centering electrodes 6, 7 are also electrically controlled in phase opposition to one another. Moreover, the centering electrode 6 is also controlled in phase opposition to the associated manipulation electrode 4 just as the centering electrode 7 is also controlled in phase opposition to the associated manipulation electrode 5. In this manner, the suspended biological cells 2 in the carrier flow channel 1 are focused in the central plane, which prevents a touching contact of the biological cells 2 with the channel walls of the carrier flow channel 1.

However, the centering electrodes 6, 7 and the manipulation electrodes 4, 5 do not have to be controlled exactly in phase opposition (that is, with a phase shift of 180°) but rather other phase shifts are also possible within the scope of the invention. This phase shift can be as desired between the electrodes on the upper channel wall and those on the lower channel wall, which shift is generally between 90° and 270°. For electrodes in one plane, e.g., manipulation electrode and centering electrode on the upper channel wall, the shift is generally in the range of 135°-225° (180°±45°).

Moreover, the centering electrodes 6, 7 and the manipulation electrodes 4, 5 can also be controlled with different frequencies and voltages, as will be described in detail later.

FIGS. 3A-3D show different views of the electrode arrangement 3 in the microfluidic system in accordance with the invention, of which FIGS. 3B-3C show the particular electrode field distribution. FIGS. 3A and 3B contain a top view representation of the electrode arrangement 3 in direction z whereas FIGS. 3C and 3D represent sectional images in the y-z plane or the x-z plane, respectively.

FIGS. 2A-2D show corresponding views for comparison in a traditional electrode arrangement without the centering electrodes 6, 7. It is apparent from them that the biological cells 2 are pressed in the direction of the channel wall in the traditional electrode arrangement, which is especially apparent from FIGS. 2C and 2D. In contrast to the above, the biological cells 2 are centrally focused in the electrode arrangement 3 in accordance with the invention, as is especially apparent from FIGS. 3C and 3D.

FIGS. 4A and 4B show an alternative exemplary embodiment of an electrode arrangement in accordance with the invention with semicircular manipulation electrodes 8, in which the representations on the left side show a corresponding traditional electrode arrangement without centering electrodes whereas the representation on the right side shows the field distribution in an electrode arrangement in accordance with the invention with a centering electrode 9. It is also apparent from these representations that the centering electrode 9 brings about a centering of the biological cells 2 in the central plane of the carrier flow channel 1 and additionally a fixing counter to the flow in the x direction.

Finally, the FIGS. 5A and 5B show an alternative exemplary embodiment of an electrode arrangement in accordance with the invention in which a circular ring-shaped manipulation electrode (with boundary 10, 11) and a likewise concentric, centrally arranged centering electrode 12 are provided. The manipulation electrode (10, 11) and the centering electrode 12 are arranged here in a common plane on the upper channel wall or on the lower channel wall of the carrier flow channel 1, respectively, and are thus aligned in a coplanar manner. The biological cells 2 can be arranged on closed paths in this exemplary embodiment, as is especially apparent from the representation in FIG. 5A.

FIGS. 6A-6C show further alternative exemplary embodiments of electrode arrangements 13, 13′ and 13″, respectively, in accordance with the invention, that each have a manipulation electrode 14, 14′ and 14″ and a centering electrode 15, 15′ and 15″. Such an electrode arrangement 13, 13′ and 13″ is arranged in the carrier flow channel 1 on the upper channel wall and on the lower channel wall.

FIGS. 7A and 7B show further exemplary embodiments of electrode arrangements 16 and 17, respectively, in accordance with the invention, in which several hook-shaped manipulation electrodes 18-21 are arranged adjacent to each other in the carrier flow channel 1 in the direction of flow. A centering electrode 22-25 is arranged upstream before the individual manipulation electrodes 18-21 here in order to center biological cells 2 in the central plane of carrier flow channel 1.

The difference between the exemplary embodiments according to FIGS. 7A and 7B resides in the electrical supply of the manipulation electrodes 18-21 and the centering electrodes 22-25.

Thus, the manipulation electrodes 18-21 of the electrode arrangement 16 according to FIG. 7A are electrically jointly controlled and are therefore electrically connected to each other. In contrast thereto, the manipulation electrodes 18-21 in the electrode arrangement 17 according to FIG. 7B are controlled electrically separated from each other, so that the manipulation electrodes 18-21 are also not connected to each other electrically.

On the other hand, in the electrode arrangement 16 according to FIG. 7A the centering electrodes 22-25 are electrically jointly controlled, which is also the case in the electrode arrangement 17 according to FIG. 7B.

Even several of the electrode arrangements 16 or 17, respectively, represented in FIG. 7A or 7B, respectively, can be arranged in series in the direction of flow in the carrier flow channel of the microfluidic system in accordance with the invention. This offers the possibility of storing particles in defined arrays.

Several electrode arrangements in accordance with FIG. 7A/B can be arranged in series in the direction of flow in order to store particles in defined arrays.

Finally, FIG. 8 shows a diagram showing the functional dependency of several different values on the electrode width and of the electrode distance.

A curve 26 reproduces here the dependency of the warming ΔT of the suspended biological cells 2 as a function of the ratio between electrode width and electrode distance between the planes at constant voltage. It is apparent from the course of the curve 26 that the warming ΔT of the suspended biological cells 2 increases with the electrode width and decreases with the electrode distance. It needs to be mentioned here that the warming of the biological cells 2 by the dielectrophoretic electrode arrangement can be damaging to the biological cells 2 and is therefore undesirable.

On the other hand, a further curve 27 shows the dependency of the force F exerted by the dielectrophoretic electrode arrangement on the biological cell 2 as a function of the ratio of the electrode width to the electrode distance. It is apparent from the course of the curve 27 that the exerted force F increases with the electrode width and decreases with the electrode distance.

Finally, a further curve 28 shows the ratio of the desired force F to the undesirable warming ΔT of the suspended cells as a function of the ratio of electrode width to electrode distance. It is apparent from the course of the curve 28 that a certain operating range is especially advantageous in which the ratio of electrode width to electrode distance is approximately between 0.15 to 0.5. In this range the force exerted by the electrode arrangement on the suspended particles is relatively large in proportion to the undesirable warming ΔT.

FIGS. 9A to 9E show further exemplary embodiments of electrode arrangements that can be used in a microfluidic system in accordance with the invention.

The individual electrode arrangements each consist of a centering electrode 29 and of a manipulation electrode 30. The centering electrode 29 would thus take the place in the exemplary embodiment according to FIG. 1 of the centering electrodes 6 or 7, respectively, while the manipulation electrode 30 replaces the manipulation electrodes 4 or 5, respectively.

The different electrode arrangements according to FIGS. 9A to 9E differ here by the form of the centering electrode 29.

Thus, the centering electrode 29 can be rectangular, triangular, drop-shaped, angular or box-shaped, as is apparent from the various figures.

Furthermore, FIG. 10 shows different views of a further exemplary embodiment of an electrode arrangement in a microfluidic system in accordance with the invention. This exemplary embodiment largely agrees with the previously described exemplary embodiment represented in FIGS. 1 and 3 so that in order to avoid repetitions the previous description is referred to.

This exemplary embodiment has the particularity that the upper manipulation electrode 4 is offset in the direction of flow compared with the lower manipulation electrode 5.

In the same manner, the upper centering electrode 6 is also arranged offset in the direction of flow compared with the lower centering electrode 7.

The offset corresponds here to one half of the distance between the manipulation electrodes 4, 5 and the associated centering electrodes 6, 7.

The images on the left side of FIG. 10 show field distributions that are produced when the manipulation electrodes 4, 5 on the one hand and the centering electrode 6, 7 on the other hand are controlled with the same electrical voltage.

On the other hand, field distributions are represented on the right side in FIG. 10 that are produced when the centering electrodes 6, 7 are controlled with an electrical voltage three times as great as the manipulation electrodes 4, 5.

Furthermore, FIG. 11 shows different views of a further exemplary embodiment of an electrode arrangement in a microfluidic system in accordance with the invention. This exemplary embodiment largely coincides with the previously described exemplary embodiment represented in FIGS. 1 and 3 so that in order to avoid repetitions the previous description is referred to.

This exemplary embodiment has the particularity that there is a phase shift of 90° between the manipulation electrode 4 and the centering electrode 6 on the upper channel wall on the one hand and the manipulation electrode 5 and the centering electrode 7 on the lower channel wall on the other hand.

Moreover, the manipulation electrodes 4, 5 on the one hand and the centering electrodes 6, 7 on the other hand are also controlled with a phase shift of 90°.

This is represented in the left column of FIG. 11. On the other hand the right column shows a control with phase opposition but using a quadratic centering electrode.

Furthermore, FIG. 12 shows different views of a further exemplary embodiment of an electrode arrangement in a microfluidic system in accordance with the invention. This exemplary embodiment largely coincides with the previously described exemplary embodiment represented in FIGS. 1 and 3 so that in order to avoid repetitions the previous description is referred to.

This exemplary embodiment has the particularity that the manipulation electrodes 4, 5 on the one hand and the centering electrodes 6, 7 on the other hand are controlled with different frequencies.

The images in the left column show the field distribution for the case that the manipulation electrodes 4, 5 and the centering electrodes 6, 7 are controlled with the same voltage values, with the control frequency F1 respectively F2 being selected in such a manner that the cells 2 experience an equally strong polarization in both fields.

On the other hand, in the images in the right column the polarization of the particle relative to the medium at the frequency F2 is only ¼ the polarization at the frequency F1.

Even when controlling with two different (not necessarily consumerable) frequencies F1, F2 the cells 2 are focused in the Z direction. However, in the case of moderate voltages they are not centrally held in the horizontal X-Y central plain but rather can be held in two positions according to the equilibrium with the hydrodynamic force. This makes two further types of operation possible:

On the one hand, two cells 2 or particles can be conducted to one another or separated from one another by the inverse process if the bond is not too strong by switching to control with a unified frequency or by absolute or relative weakening of the manipulation electrodes (lower voltage, frequency change, increase of the flow rate). This can be utilized to determine bonding constants and/or to purposefully actuate and/or to influence cells, especially immune cells.

On the other hand, a conclusion can be made by variation of one of the two frequencies F1, F2 from the positional change of the cells 2 about their dielectrical properties (in the images in the right column the two cells 2 are further apart from one another). This makes the dielectrophoresis spectrum readily accessible.

The exemplary embodiment according to the FIGS. 13A and 13B largely coincides with the previously described exemplary embodiments represented in FIGS. 5A and 5B so that in order to avoid repetitions the previous description is referred to and the same reference numerals are used for corresponding components.

A particularity of this exemplary embodiment is the diameter of the manipulation electrode 10, which is smaller in comparison to the exemplary embodiment according to FIGS. 5A, 5B.

Furthermore, it needs to be mentioned that the manipulation electrodes 10, 11 on the one hand and the centering electrode 12 on the other hand are controlled in phase opposition in this exemplary embodiment, as is apparent from the phase indication in FIG. 13B.

Moreover, there is also a phase-opposition control in this exemplary embodiment of the electrodes on the upper channel wall on the one hand and on the lower channel wall on the other hand. Thus, the manipulation electrode 10 on the upper channel wall on the one hand and the manipulation electrode 10 on the lower channel wall are controlled in phase opposition. In the same manner the centering electrodes 12 on the upper channel wall are also controlled in phase opposition to the centering electrodes 12 on the lower channel wall.

The electrical fields are formed in this electrode structure in such a manner that the cells 2 are centrally trapped and not on a ring as FIG. 5.

The exemplary embodiment according to FIGS. 14A and 14B largely coincides with the previously described exemplary embodiment represented in FIGS. 13A and 13B so that in order to avoid repetitions the previous description is referred to and the same reference numerals are used for corresponding components.

This exemplary embodiment has the particularity that the centering electrodes 12 are connected to earth. As a result thereof, the trapped cells 2 are brought in the Z direction into the vicinity of manipulation electrode 10 and therewith into zones with a calmer flow. This has the advantage that a stable holding can be realized in free solution with reduced electrical (heating) power.

The exemplary embodiment according to FIGS. 15A and 15B again largely coincides with the previously described exemplary embodiment represented in FIGS. 14A and 14B so that in order to avoid repetitions the previous description is referred to and the same reference numerals are used for corresponding components.

A particularity of this exemplary embodiment is the electrical control of the centering electrodes 12 on the top and on the bottom of the carrier flow channel. Thus, the control of the centering electrode 12 on the upper channel wall takes place with earth whereas the centering electrode 12 on the lower channel wall is controlled in phase opposition to the upper manipulation electrode 10, as is apparent from the phase indication in FIG. 15B.

The exemplary embodiment according to FIGS. 16A and 16B largely coincides with the previously described exemplary embodiment represented in FIGS. 13A and 13B so that in order to avoid repetitions the previous description is referred to and the same reference numerals are used for corresponding components.

This exemplary embodiment has the particularity that the manipulation electrode 10 consists of four circular ring-shaped electrode segments 31A, 31B, 31C and 31D. The individual electrode segments 31A-31D are electrically connected to each other and are only spatially separated from each other in order that the trapped cells 2 can enter more readily in the X direction and Y direction into the field cage and leave it.

The exemplary embodiment according to FIGS. 17A and 17B again largely coincides with the previously described exemplary embodiments so that in order to avoid repetitions the previous description is referred to and the same reference numerals are used for corresponding components.

A particularity of this exemplary embodiment is the electrical control of the manipulation electrode 10 and of the centering electrodes 12.

On the other hand, in this exemplary embodiment the manipulation electrode 10 on the top of the channel wall and the manipulation electrode 10 on the bottom of the channel wall are controlled with a phase difference of 90°.

Furthermore, in this exemplary embodiment even the two centering electrodes 12 on the top or on the bottom of the carrier flow channel, respectively, are controlled in phase opposition. In this manner rotation fields are generated in the field cage.

FIG. 18 shows a matrix-shaped arrangement of a plurality of circular-shaped and circular ring-shaped electrode arrangements 32 in which the individual electrode arrangements 32 each have manipulation electrodes and centering electrodes, as was described above. The control of the individual electrode arrangements 32 takes place by row control lines 33 and column control lines 34. In order to cut out a certain electrode arrangement 32, the associated row control lines 33 and the associated column control lines 34 are connected to earth or to free potential. As a result, all cells remain fixed with the exception of the cell held in the particular electrode arrangement 32. On the other hand, in the concerned electrode arrangement 32 all electrodes are on earth so that the particle present in it can leave the associated electrode arrangement 32 with the carrier flow.

FIGS. 19A-19B show different variants of electrode arrangements in accordance with the invention with centering electrodes 35 and manipulation electrodes 36, wherein the manipulation electrodes 36 consist of four segments that surround the centering electrode 35.

In addition, the manipulation electrodes 36 also have funnel-shaped electrode arrangements as initially explained in the description of the state of the art. These funnel-shaped electrode arrangements facilitate the entering of particles into the electrode structure.

Finally, FIG. 20 shows a plurality of electrode arrangements that largely corresponds to the electrode arrangements according to FIGS. 19A and 19B so that in order to avoid repetitions the previous description is referred to and the same reference numerals are used for corresponding components.

A particularity of this exemplary embodiment is that particles switches 37 are arranged downstream behind the individual electrode arrangements and make it possible to transport the exiting particles selectively into the electrode structure located downstream behind them or laterally deflect them.

The invention is not limited to the previously described exemplary embodiments but rather a plurality of variants and modifications are possible that also make use of the inventive concept and therefore fall into the scope of protection.

List of reference numerals:
1 carrier flow channel
2 cell
3 electrode arrangement
4, 5 manipulation electrodes
6, 7 centering electrodes
8 manipulation electrodes
9 centering electrode
10, 11 manipulation electrodes
12 centering electrode
13, 13′, 13″ electrode arrangement
14, 14′, 14″ manipulation electrode
15, 15′, 15″ centering electrode
16, 17 electrode arrangements
18-21 manipulation electrodes
22-25 centering electrodes
26-28 curves
29 centering electrode manipulation electrode
31A-31D electrode segments
32 electrode arrangements
33 row control lines
34 column control lines
35 centering electrode
36 manipulation electrode
37 particle switch

1-36. (canceled)

37. A microfluidic system comprising:
a) a carrier flow channel for receiving a carrier flow with particles suspended therein, and
b) at least one electrode arrangement arranged in the carrier flow channel for manipulating the suspended particles, wherein the at least one electrode arrangement comprises:
(i) at least two manipulation electrodes,
(ii) at least two centering electrodes adapted to center the suspended particles at a right angle to a direction of flow,
wherein the centering electrodes are arranged in the carrier flow channel at least partially upstream before one of the two manipulation electrodes, and the centering electrodes are at least partially surrounded by the manipulation electrodes.

38. The microfluidic system according to claim 37, wherein the centering electrodes have a lesser spatial extension transversely to the direction of flow than the manipulation electrodes.

39. The microfluidic system according to claim 37, wherein the manipulation electrodes are curved counter to the direction of flow.

40. The microfluidic system according to claim 37, wherein the manipulation electrodes are closed in an arcuate form.

41. The microfluidic system according to claim 37, wherein the manipulation electrodes are closed in an hook-shaped form.

42. The microfluidic system according to claim 37, wherein the manipulation electrodes are closed in a ring-shaped form.

43. The microfluidic system according to claim 37, wherein the electrode arrangement has several manipulation electrode pairs and centering electrodes associated therewith.

44. The microfluidic system according to claim 43, wherein the centering electrode pairs are at least partially electrically connected to each other and can be at least partially electrically jointly controlled and wherein the manipulation electrode pairs are at least partially electrically connected to each other and can be at least partially electrically jointly controlled.

45. The microfluidic system according to claim 44, wherein the centering electrodes and the manipulation electrodes are adjacently arranged in the carrier flow channel relative to the direction of flow.

46. The microfluidic system according to claim 37, wherein the manipulation electrodes are arranged at a certain electrode distance from each other and have a certain lateral electrode width, the electrode width being in a range of 10% to 50% of the electrode distance.

47. The microfluidic system according to claim 37, wherein the two centering electrodes can be electrically controlled separately from one another.

48. The microfluidic system according to claim 37, wherein the two manipulation electrodes can be electrically controlled separately from one another.

49. The microfluidic system according to claim 37, wherein the two manipulation electrodes can be electrically controlled separately from the centering electrodes.

50. The microfluidic system according to claim 37, wherein the two manipulation electrodes and the two centering electrodes are substantially planar.

51. The microfluidic system according to claim 37, wherein the two manipulation electrodes on the one hand and the two centering electrodes on the other hand are arranged in pairs in a coplanar manner.

52. The microfluidic system according to claim 37, wherein the centering electrodes and the manipulation electrodes have a distance from one another in the direction of flow that is in a range of ⅛ to twice the channel height.

53. The microfluidic system according to claim 37, wherein the carrier flow channel has a cross section of flow in the range of 0.006 mm² to 0.6 mm².

54. The microfluidic system according to claim 37, wherein the carrier flow channel has a height in a range of 1 μm to 400 μm.

55. The microfluidic system according to claim 37, wherein the carrier flow channel has a width in a range of 5 μm to 1.5 mm.

56. The microfluidic system according to claim 37, wherein the electrode arrangement is a dielectrophoretic electrode arrangement.

57. The microfluidic system according to claim 37, wherein the centering electrodes and the manipulation electrodes have a shape selected from the group consisting of round, circular, elliptical, rectangular, triangular and drop-shaped.

58. The microfluidic system according to claim 56, wherein the centering electrodes surround the manipulation electrodes in a ring-shaped manner.

59. The microfluidic system according to claim 58, wherein the ring-shaped centering electrodes have several circular ring-shaped segments that are galvanically connected to each other and are spatially separated from each other.

60. The microfluidic system according to claim 37, wherein the two manipulation electrodes arranged in a coplanar manner and the two centering electrodes of the electrode arrangement are arranged offset from each other in the direction of flow.

61. The microfluidic system according to claim 37, characterized by a plurality of electrode arrangements each with at least two manipulation electrodes and at least two centering electrodes, wherein individual electrode arrangements are arranged in a matrix shape in rows and columns.

62. The microfluidic system according to claim 61, wherein
at least one control line is provided for individual rows that is connected to the electrode arrangements of a particular row and controls the electrode arrangements jointly but independently of the electrode arrangements of other rows, and
at least one control line is provided for individual columns that is connected to the electrode arrangements of a particular column and controls them jointly but independently of the electrode arrangements of other columns.

63. A cell sorter with a microfluidic system in accordance with claim 37.

64. A control method for an electrode arrangement in a microfluidic system with two manipulation electrodes and two centering electrodes arranged upstream before the manipulation electrodes, wherein the centering electrodes are each arranged in the carrier flow channel at least partially upstream before one of the two manipulation electrodes and are surrounded by the two manipulator electrodes, wherein the manipulation electrodes and the centering electrodes associated with them are electrically controlled in phase opposition or in a single-phase manner.

65. The control method according to claim 64, wherein the centering electrodes in the carrier flow channel have a smaller spatial extension transversely to a direction of flow than the manipulation electrodes.

66. The control method according to claim 64, wherein a manipulation electrode and a centering electrode associated therewith are arranged in two parallel planes, the manipulation electrodes and centering electrodes being controlled with a phase shift of 90° between the planes.

67. The control method according to claim 64, wherein the centering electrodes are cut out when a particle has been fixed by the manipulation electrodes.

68. The control method according to claim 64, wherein the centering electrodes are switched to earth or potential-free in order to be cut out.

69. The control method according to claim 64, wherein the centering electrodes are briefly controlled with an elevated electrical voltage before being cut out.

70. The control method according to claim 64, wherein a flow rate in the carrier flow channel is briefly elevated before the centering electrodes are cut out.

71. The control method according to claim 64, wherein the centering electrodes are used as impedance measuring electrodes.

72. The control method according to claim 64, wherein the centering electrodes on the one hand and the manipulation electrodes on the other hand are controlled with different voltages relative to each other.

73. The control method according to claim 64, wherein the centering electrodes on the one hand and the manipulation electrodes on the other hand are controlled with different frequencies relative to each other.

74. The control method according to claim 64, wherein the centering electrodes on the one hand and the manipulation electrodes on the other hand are controlled with an adjustable phase position relative to each other.

75. A method for determining dielectrical properties of particles, comprising the use of the microfluidic system according to claim 1.

76. A method for cell activation and for influencing cells, comprising the use of the microfluidic system according to claim 1.
